(19) United States
(12) Patent Application Publication
(10) Pub. No.: US 2006/0136614 A1
(43) Pub. Date: Jun. 22, 2006

(54) System and method for variable length aggregate acknowledgements in a shared resource network

(75) Inventors: Naveen Kumar Kakani, Irving, TX (US); Srinivas Sreemanthula, Flower Mound, TX (US); Yousuf Saifullah, Flower Mound, TX (US)

Correspondence Address: HAYNES AND BOONE, LLP, 901 MAIN STREET, SUITE 3100, DALLAS, TX, 75202, US

(73) Assignee: Nokia Corporation, Espoo (FI)

(21) Appl. No.: 11/191,649

(22) Filed: Jul. 28, 2005

Related U.S. Application Data
(60) Provisional application No. 60/605,580, filed on Aug. 30, 2004.
(60) Provisional application No. 60/592,414, filed on Jul. 30, 2004.

(51) Int. Cl. G06F 3/00

(52) U.S. Cl. 710/30

(57) ABSTRACT

A system and method for producing a variable length aggregate acknowledgment frame in a shared resource network is provided. A plurality of frames is received, and receipt status information regarding the plurality of frames is generated. An aggregate acknowledgment frame comprising an acknowledgment information field containing the receipt status information is produced. A length of the receipt status information is dependent on a number of the plurality of frames.

### RELATED APPLICATION DATA

This patent application claims the benefit of provisional U.S. Patent Application Ser. No. 60/605,580, filed Aug. 30, 2004 and provisional U.S. Patent Application Ser. No. 60/592,414, filed Jul. 30, 2004.

### FIELD OF THE INVENTION

The present invention relates to shared resource network technologies and, more particularly, to mechanisms for enhancing channel utilization of a shared resource network. Still more particularly, the present invention provides a system and method for providing variable length aggregated acknowledgments in a shared resource network.

### BACKGROUND

Many contemporary wireless terminals are adapted to provide a wide variety of telecommunication services. For instance, a terminal may be capable of providing circuit-switched speech and data transfer services as well as packet-switched data transfer services and messaging services. These services may be provided via a common network or by different types of networks. For example, packet-switched data transfer services may be provided by a connection between a terminal and a wireless local area network (WLAN) access point. The circuit-switched services, on the other hand, may be provided by a connection between the terminal and a public land mobile network (PLMN).

WLANs are becoming increasingly popular for both business and residential applications. For instance, many companies are deploying WLANs in place of, or as an enhancement to, the corporate local area network. Additionally, many service industry businesses, e.g., restaurants and hotels, have deployed WLANs to provide customers with access to the Internet or other data networks. As WLANs have become increasingly more widespread, the number of applications designed for execution on WLAN-compliant stations has increased as well. For example, typical WLAN-compliant stations feature text messaging applications, Internet browsers, and streaming content players among other applications. A user may concurrently run any number of applications on a WLAN-compliant station.

In a WLAN, a responder station is often required to acknowledge the receipt of data received from an initiator station. An acknowledgement (ACK) signal sent from a responder station to the initiator station provides a confirmation to the initiator station that the responder station correctly received transmitted data. In WLAN-compliant devices, ACKs are generated at the medium access control (MAC) layer. Such an acknowledgment mechanism consumes valuable system bandwidth. It is particularly desirable to minimize signaling and control utilization of wireless resources in a shared resource wireless network as wireless system resources are finite and limited by the system bandwidth.

Various improvements to the acknowledgment mechanism in IEEE 802.11 networks have been developed. For example, a block acknowledgment mechanism allows a responder to delay generation and transmission of an acknowledgement until a plurality of frames has been received. In this manner, a single acknowledgment frame may be conveyed from the receiver to the initiator to confirm receipt of several frames. However, this implementation requires that each frame that is acknowledged in the block acknowledgment belong to a common data stream. That is, each frame acknowledged by the block acknowledgment must be targeted to the same application or processing entity. Moreover, conventional block acknowledgements are of a fixed size and thus consume a fixed amount of the acknowledgement frame regardless of the number of frames that are being acknowledged.

### SUMMARY

It would be advantageous to provide a system and method for an improved acknowledgment mechanism in a shared resource network. It would be further advantageous to provide an acknowledgment mechanism for acknowledging receipt of a plurality of frames in a shared resource network. It would still be further advantageous to provide an acknowledgment mechanism that facilitates receipt acknowledgment of frames of multiple data streams with a single acknowledgment signal. It would still be further advantageous to provide an acknowledgment mechanism that facilitates receipt acknowledgment of a variable number of frames of a variable number of data streams.

Embodiments of the present invention provide a system and method for producing a variable length aggregate acknowledgment frame in a shared resource network. A plurality of frames is received, and receipt status information regarding the plurality of frames is generated. An aggregate acknowledgment frame comprising an acknowledgment information field containing the receipt status information is produced. A length of the receipt status information is dependent on a number of the plurality of frames.

### BRIEF DESCRIPTION OF THE DRAWINGS

Aspects of the present disclosure are best understood from the following detailed description when read with the accompanying figures.

FIG. 1 is a simplified block diagram of an exemplary network environment;

FIG. 2 is a diagrammatic representation of an acknowledgment frame for acknowledging receipt of data frames in a wireless local area network;

FIG. 3 is a diagrammatic representation of a frame sequence exchanged between an initiator and responder station;

FIG. 4 is a diagrammatic representation of an embodiment of a variable length aggregate acknowledgment frame for acknowledging receipt of data frames in a shared resource network;

FIG. 5 is a diagrammatic representation of another embodiment of a variable length aggregate acknowledgment frame for acknowledging receipt of data frames in a shared resource network;

FIG. 6 is a diagrammatic representation of another embodiment of a variable length aggregate acknowledgment frame for acknowledging receipt of data frames in a shared resource network;

FIG. 7 is a diagrammatic representation of another embodiment of an aggregate acknowledgement frame for acknowledging receipt of data frames in a shared resource network; and

FIG. 8 is a diagrammatic representation of an embodiment of a frame sequence and acknowledgment sequence exchanged between initiator and responder stations.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

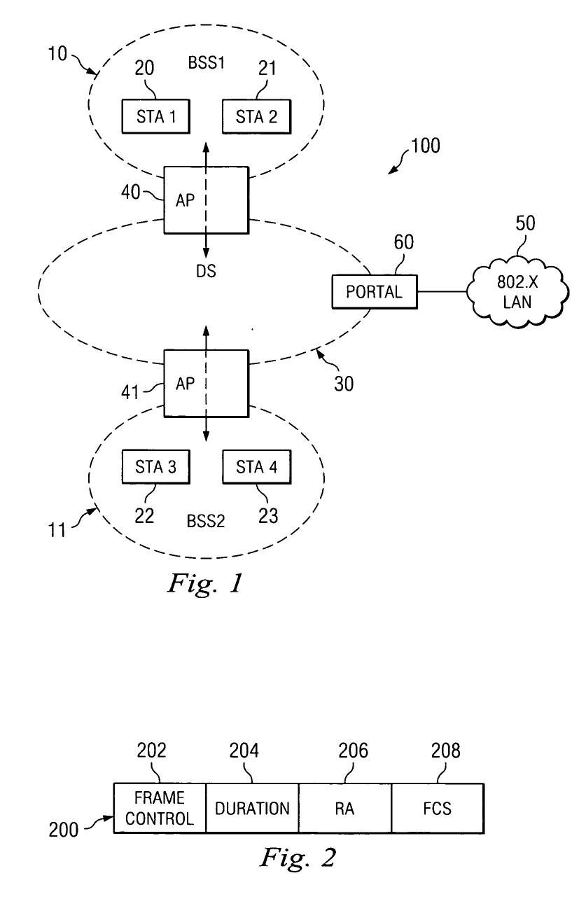

FIG. 1 is a simplified block diagram of an exemplary network 100 environment. Network 100 is an example of a shared resource network. For example, network 100 may be implemented as a wireless local area network (WLAN) conforming to the IEEE 802.11 standards. In particular, network 100 may be implemented in conformance with the IEEE 802.11 WLAN standard.

In the illustrative example, network 100 comprises two basic service sets (BSSs) 1 and 2 although any number of BSSs may be included in network 100. BSSs 1 and 2 provide respective coverage areas in which WLAN stations (STAs) 20-23 may communicate via a wireless medium with one another or with other communication or computational devices in other external networks that interface with network 100. BSSs 1 and 2 are communicatively interconnected by a distribution system (DS) 30. DS 30 enables mobile device support by providing requisite logical services for handling address to destination mapping and integration of multiple BSSs. Each BSS includes an access point (AP) that provides access to DS 30. In the illustrative example, BSSs 1 and 2 with coverage areas 10 and 11 have respective APs 40 and 41. DS 30 provided by APs 40 and 41 and BSSs 1 and 2 facilitate creation of a wireless network of arbitrary size and complexity, and the collection of DS 30 and BSSs 1-2 with coverage areas 10-11 is commonly referred to as an extended service set network. Logical integration between network 100 and non-IEEE 802.11 LANs, e.g., LAN 50, is provided by portal 60. Various other configurations of network 100 are possible. For example, coverage areas 10 and 11 may partially overlap or may be collocated. Moreover, embodiments of the invention may be deployed in a WLAN comprising a single independent BSS.

Each of STAs 20-23 may be implemented as a respective data processing system adapted for communication in a wireless network, such as a wireless laptop computer, a personal digital assistant, a cellular telephone, or other device capable of data communications. A STA may comprise a processing unit, such as a general purpose microprocessor and/or an application specific integrated circuit, a memory device, such as a random access memory, a read-only memory, or another storage device for holding machine-readable data, a communication interface, such as a wireless communication card, and various other components and peripheral devices.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory in a WLAN station or a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, or any combination thereof, executing on a single computer processor or multiple computer processors. Additionally, various steps of embodiments of the invention may provide a data structure generated, produced, received, or otherwise implemented on a computer-readable medium, such as a memory.

While the descriptions of a shared resource network, devices operating therein, and wireless medium transmissions made within the shared resource network are provided herein according to IEEE 802.11 protocols, functionality, and nomenclature, such examples are illustrative only and implementations of the invention are not limited to any particular network, network-compliant device, or network communication formats or protocols. Furthermore, descriptions of the invention provided herein in relation to implementations in an IEEE 802 conformant network are illustrative only and are provided only to facilitate an understanding of the invention. Embodiments of the present invention may be implemented on other network architectures and devices that utilize shared resources for effecting data communications.

With reference now to FIG. 2, there is shown a diagrammatic representation of an acknowledgment frame 200 for acknowledging receipt of data frames in a WLAN. Acknowledgment frame 200 is representative of a non-quality of service (non-QoS) acknowledgment signal. Acknowledgment frame 200 includes a frame control field 202, a duration field 204, a receiver address (RA) field 206, and a frame check sequence (FCS) 208. Frame control field 202, duration field 204, and RA field 206 are all components of a medium access control (MAC) header included in a MAC frame. FCS 208 may comprise, for example, a 32-bit cyclic redundancy code. Acknowledgment frame 200 is suitable for acknowledging frame receipt on a frame-by-frame basis. That is, for each received frame, an acknowledgment frame similar to that shown in FIG. 2 is conveyed from the receiving station to the transmitting station.

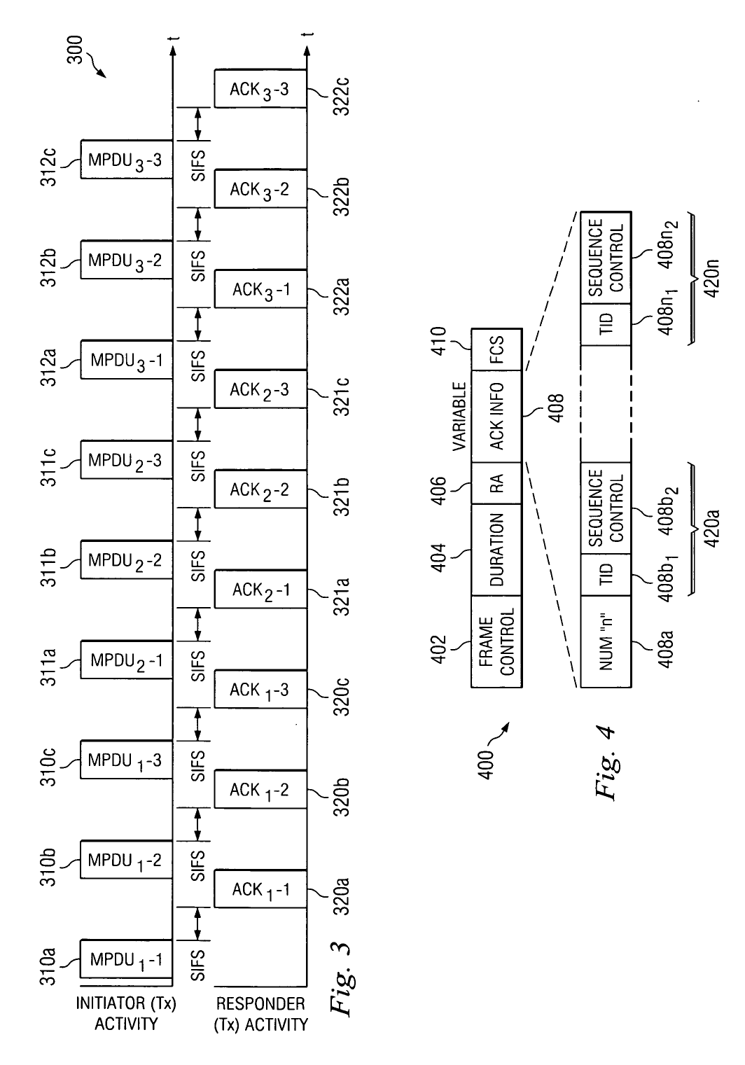

With reference now to FIG. 3, a diagrammatic representation of a frame sequence exchange between initiator and responder stations is shown. In the illustrative example, an initiator station, such as WLAN station 20 shown in FIG. 1, initiates transmission of frame sequence 300 comprising a plurality of frames 310a-312c to a responder station, such as WLAN station 23 shown in FIG. 1. Frames 310a-312c are representative of frames that contain MAC protocol data units (MPDUs) of various traffic streams, and are illustratively designated as MPDU_{X}-Y, where X designates a traffic stream and Y designates a frame number. Thus, a frame subset comprising three frames 310a-310c of a traffic stream “1” are shown transmitted from the initiator station to the responder station. Likewise, respective frame subsets of three frames 311a-311c and 312a-312c of traffic streams “2” and “3” are shown transmitted from the initiator station to the responder station.

The responder may individually acknowledge each received frame. For example, the responder station may generate and transmit an acknowledgment frame 320a in response to receipt of frame 310a. In a similar manner, the responder station individually generates and transmits acknowledgment frames 320b-322c in response to receipt of respective frames 310b-312c. In the present example, individual acknowledgment frames are illustratively designated ACK_{X}-Y, where X designates the traffic stream and Y designates the frame number for which the acknowledgment frame confirms receipt. For example, acknowledgment frame 320a is designated ACK₁-1 and thus acknowledges receipt of frame “1” of traffic stream “1”, i.e., frame 310a. As can be seen, acknowledgment frame 320a-322c is respectively transmitted by the responder to confirm receipt of each received frame 310a-312c on a frame-by-frame basis.

Improved acknowledgment mechanisms have been developed to facilitate acknowledgment of multiple frames with a single acknowledgment frame. For example, a block acknowledgment (B-ACK) mechanism is defined in the IEEE 802.11e specification that allows receipt confirmation of multiple frames with a single block acknowledgment frame. However, a conventional block acknowledgment only allows acknowledgment of multiple frames of a single traffic stream having a common traffic identifier (TID).

Therefore, it is desirable to provide techniques for acknowledging a plurality of frames of different traffic streams in a single aggregate acknowledgment (A-ACK) or high-throughput acknowledgement (HT-ACK) frame that has a variable size. In particular, acknowledgment frames are sent in response to different MAC Protocol Data Units (MPDUs) present in aggregate frames. The aggregate acknowledgment scheme described herein provides for the acknowledgement of multiple frames and accommodates traffic identifier (TID) and sequence control definitions per individual aggregate acknowledgment frame and any fragmentation defined in the forward direction sequence control. Additionally, aggregate acknowledgement frames are also provided for traffic frames that do not have any TID associated therewith, e.g., for MPDUs originated from legacy stations or devices that do not support multiple traffic streams.

In the embodiments described herein, various field sizes are described. However, such field size or length descriptions are illustrative only and are chosen to facilitate an understanding of the invention. Other field size values may also be used without departing from the teachings of the invention. For instance, a field having a particular exemplary size described herein may be implemented with a different field size in order to achieve alignment of the field with boundaries, such as a 4-bit boundary, a byte boundary, a word boundary, or a long word boundary. Such alignment may be achieved by padding the appropriate field. Additionally, field configurations provided herein are exemplary only, and various rearrangements of the order of the data fields may be made without departing from the teachings of the present invention. Numerous other variations may be implemented as will be recognized by skilled artisans.

With reference now to FIG. 4, there is shown a diagrammatic representation of an embodiment of an aggregate acknowledgment (A-ACK) frame 400 for acknowledging the receipt of data frames in a shared resource network, such as shared resource network 100 shown in FIG. 1. A-ACK frame 400 may include a frame control field 402, a duration field 404, a receiver address (RA) field 406, a variable length acknowledgment information field 408, and a frame check sequence (FCS) 408. Acknowledgment information field 408 contains information regarding the number of frames acknowledged, traffic stream(s) of acknowledged frames, and receipt status or acknowledgment information thereof. Particularly, acknowledgment information field 408 may include various subfields including a frame count field 408a that contains a numerical identifier that specifies the number, n, of frames acknowledged by A-ACK frame 400. Additionally, acknowledgment information field 408 may include one or more field sets 420a-420n of traffic identifier (TID) fields and corresponding sequence control fields respectively associated therewith. In the illustrative example, acknowledgment information field 408 may include TID identifier fields 408b₁-408n₁ and respective corresponding sequence control fields 408b₂-408n₂ for acknowledging frames of different traffic streams. For example, TID identifier field 408b₁ of field set 420a specifies a TID, and sequence control field 408b₂ of field set 420a identifies a sequence number of an acknowledged frame of the TID specified in TID identifier field 408b₁. In a similar manner, field sets 420b-420n each respectively identify a TID and sequence number of a frame of the associated TIED identifier field. Thus, A-ACK frame 400 provides a mechanism for providing acknowledgments for frames of one or more TIDs within a single A-ACK frame. In the exemplary A-ACK frame 400, frame count field 408a defines the collective number of frames acknowledged by A-ACK frame 400. Thus, A-ACK frame 400 is a variable length frame and is adapted to provide receipt status for a variable number of frames of one or more TIDs.

It may be seen that the length of the acknowledgment frame is dynamically varied dependent on the number of frames being acknowledged. Advantageously, the number of un-necessary bytes consumed by the acknowledgment frame is eliminated or otherwise minimized. Additionally, the need for repeated transmission of acknowledgement frames to acknowledge received data is minimized.

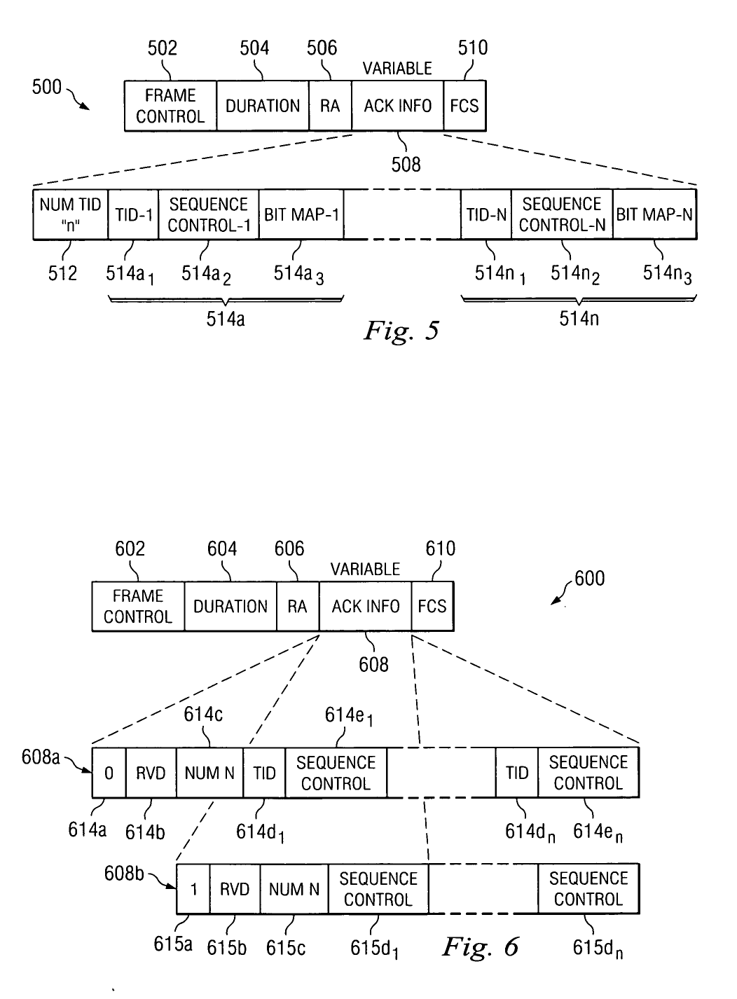

With reference now to FIG. 5, there is shown a diagrammatic representation of another embodiment of a variable length A-ACK frame for acknowledging receipt of data frames in a shared resource network. A-ACK frame 500 may include fields to provide acknowledgements for the receipt of data of one or more TIDs. A-ACK frame 500 includes a frame control field 502, a duration field 504, an RA field 506, a variable length acknowledgment information field 508, and a FCS 510. Acknowledgment information field 508 contains various subfields that contain information regarding the number of TIDs having frames acknowledged by A-ACK frame 500. Particularly, acknowledgment information field 508 includes a TID count field 512 that contains a numerical identifier, N, to indicate the number of TIDs having frames acknowledged by A-ACK frame 500. Each TID that has one or more frames acknowledged by A-ACK frame 500 is uniquely associated with one of field sets 514A-514N. Each field set 514A-514N may include a TID identifier field that contains an identification of the associated TID, a sequence control field that specifies starting sequence control information, and an acknowledgment bitmap field that includes a bitmap having acknowledgement information of one or more frames of the associated TID. In the illustrative example, TID count field 512 specifies that A-ACK frame 500 includes acknowledgement data of N traffic streams or TIDs. Thus, N field sets 514A-514N are included in acknowledgment information field 508. For example, TID identifier field 514a, specifies a TID of “1” (TID-1). Thus, sequence control field 514a₂ contains a sequence number of a first frame of TID-1 that has receipt status identified by a first bit value in a bitmap maintained in bitmap field 514a₃. Additional frames of TID-1 may have receipt status provided by respective bit values of the bitmap maintained in bitmap field 514a₃. In a similar manner, field sets 514B-514N each provide acknowledgement information of one or more frames of respective TIDs. Notably, a TID value identifying a particular TID is sent only once in A-ACK frame 500 formatted as shown in FIG. 5. Additionally, an acknowledgement bitmap for each TID is included in A-ACK frame 500 along with a single frame sequence number rather than including each acknowledged frame sequence number as is performed in A-ACK frame 400 described with reference to FIG. 4. An acknowledgement bitmap included in one of the acknowledgement bitmap fields 514a₃-514n₃ provides receipt status of frames with sequence numbers calculated with respect to a starting sequence number in a corresponding sequence control field. For example, assume the sequence number of sequence control field 514a₂ is set to a value of “600.” In this instance, the first bit value (having a bit position “0”) of the acknowledgment bitmap in acknowledgement bitmap field 514a₃ indicates the receipt status of a TID-1 frame having a sequence number of “600.” Additional bit values (if any) of the acknowledgement bitmap in acknowledgement bitmap field 514a₃ respectively indicate the receipt status of frames having sequence numbers with an offset from the sequence number of sequence control field 514a₂ that corresponds with the bit position of the acknowledgement bitmap. For example, if the value of the bit in position 4 of the acknowledgement bitmap in acknowledgment bitmap field 514a₃ is asserted (i.e., bit position 4 is set to “1”), a TID-1 frame having a sequence number “604” is indicated to have been correctly received.

With reference now to FIG. 6, a diagrammatic representation of another embodiment of a variable length A-ACK frame 600 for acknowledging receipt of data frames in a shared resource network is shown. A-ACK frame 600 provides acknowledgment support for both STAs that produce data for multiple TIDs and legacy STAs not equipped with any TID support. A-ACK frame 600 includes a frame control field 602, a duration field 604, a RA field 606, a variable length acknowledgment information field 608, and a FCS 610. Acknowledgment data maintained in acknowledgment information field 608 may be generally formatted as the acknowledgment information described in either of A-ACK frame 400 shown in FIG. 4 or A-ACK frame 500 shown in FIG. 5. That is, acknowledgement information in acknowledgement information field 608 may be implemented as field sets respectively comprising a TID identifier and sequence number, or the acknowledgment information may be implemented as field sets respectively comprising a TID identifier, starting sequence number, and an acknowledgement bitmap field. In the illustrative example, acknowledgement information is implemented as TID identifiers and corresponding frame sequence numbers in the diagram of variable length acknowledgement information field format 608A. Additionally, acknowledgment information in acknowledgment information field 608 includes a bit indicator that specifies whether TID frame(s) acknowledged by A-ACK frame 600 are associated with a TID. For example, acknowledgement information field 608 may be formatted according to acknowledgment information field format 608a. Acknowledgment information field format 608a includes a bit field 614a and a reserved bit field 614b. Bit field 614a may have a bit value (e.g., “0”) that indicates frames having frame receipt status provided by A-ACK frame 600 are associated with a TID. Accordingly, acknowledgement information field 608 may include a frame count field 614c with a numerical identifier of the number, N, of frames acknowledged by A-ACK frame 600 and N field sets comprising frame acknowledgment information. In the diagrammatic illustration, N field sets each respectively comprise a TID identifier field 614d₁-614d_{N} and an associated sequence control field 614e₁-614e_{N}.

Alternatively, A-ACK frame 600 may be configured to provide acknowledgement information for frames that do not have a TID associated therewith. To this end, acknowledgement information field 608 is configured according to acknowledgement information field format 608b. A bit field 615a is set to a bit value (e.g., “I”) that indicates frames having frame receipt status provided by A-ACK frame 600 are not associated with a TID. In this instance, acknowledgement information field 608 includes a reserved bit field 615b, a frame count field 615c that indicates the number of frames N having receipt status defined by A-ACK frame 600, and N sequence control fields 615d₁-615d_{N} that each respectively identifies a sequence number of a received frame. Notably, acknowledgement information field format 608B does not include a field for maintaining TID data when bit field 615a has a value that indicates the acknowledged frames are not associated with a TID. As noted above, A-ACK frame 600 may be configured to support TI) or non-TID frame acknowledgments by including an acknowledgment bitmap similar to that described above with reference to FIG. 5.

As described above with respect to FIGS. 4-6, the acknowledgement information field of an A-ACK frame described herein is variable in length, i.e., the particular size of the acknowledgement information field is dependent on the number of frames that are acknowledged by the A-ACK frame. In accordance with various embodiments described herein, the length of frame acknowledgement information may be explicitly or implicitly defined in an A-ACK frame.

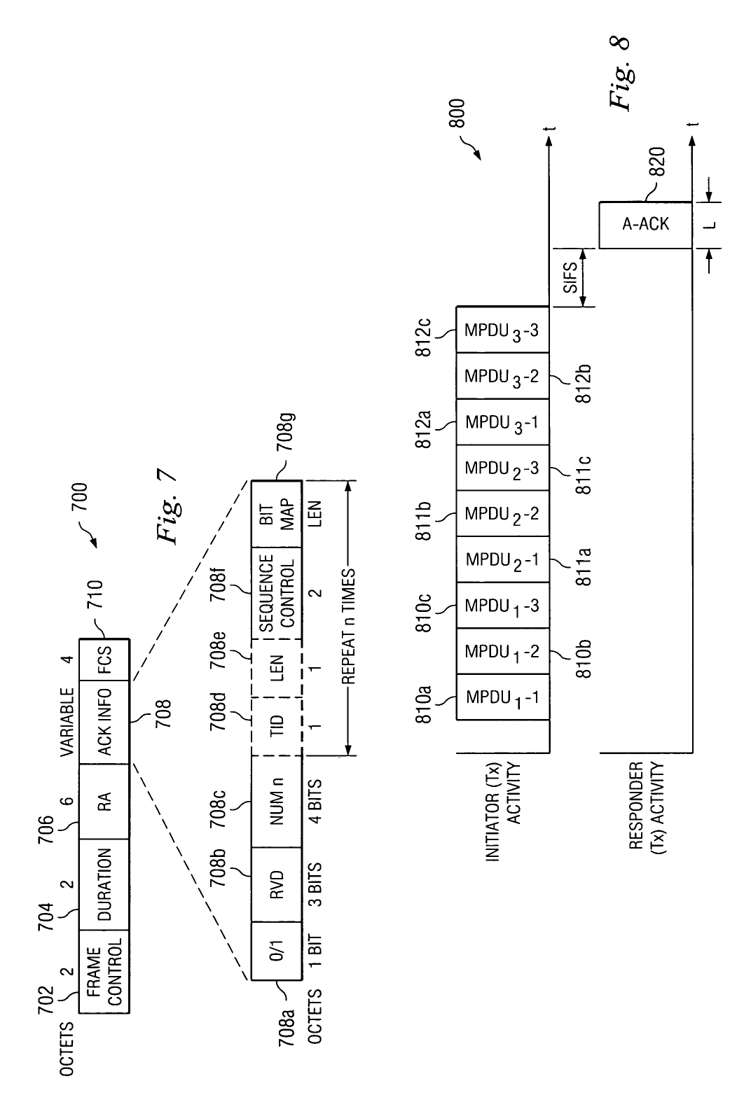

With reference now to FIG. 7, a diagrammatic representation of another embodiment of an A-ACK frame 700 is shown. A-ACK frame 700 includes a frame control field 702, a duration field 704, a receiver address (RA) field 706, a variable length acknowledgement information field 708, and a FCS 710. In the illustrative implementation, variable length acknowledgment information field 708 comprises various subfields including a bit field 708a, a reserved field 708b, a count field 708c, optional TID identifier field 708d and optional length field 708e (both illustratively designated with dashed lines), sequence control field 708f, and acknowledgment bitmap field 708g. TID frame acknowledgement data is carried in one or more field sets comprising optional TID identifier field 708d and length field 708e, sequence control field 708f, and bitmap field 708g.

In the event that A-ACK frame 700 is to provide receipt status regarding non-TID frames, bit field 708a may be set to a particular value, e.g., a bit value of “1”, to provide an indication that A-ACK frame 700 includes non-TID acknowledgement information. In this configuration, the value n of count field 708c is set to specify the number of non-TID frames acknowledged by bitmap field 708g (or the length of the bitmap in bitmap field 708g), and TID identifier field 708d and length field 708e may be excluded. In this instance, the acknowledgment bitmap in bitmap field 708g may be either of a fixed or variable length. A single instance of the field set comprising sequence control field 708f and acknowledgment bitmap field 708g is included in A-ACK frame 700 when providing acknowledgement status for non-TID frames.

In the event that A-ACK frame 700 is to provide receipt status regarding frames of one or more TIDs, bit field 708a may be set to a particular value, e.g., a bit value of “0”, to provide an indication that A-ACK frame 700 includes acknowledgement information of one or more TIDs. In this configuration, the value n of count field 708c is set to indicate the number of TIDs having frames acknowledged by A-ACK frame 700, and instances of TID identifier field 708d and length field 708e are included in acknowledgement information field 708 for each TID having frames acknowledged by A-ACK frame 700. The illustrative example shows a single instance of TID identifier field 708d, length field 708e, sequence control field 708f, and acknowledgment bitmap field 708g to simplify the illustration. When A-ACK frame 700 provides acknowledgment information for frames of multiple TIDs, multiple field sets of TID identifier field 708d, length field 708e, sequence control field 708f, and acknowledgement bitmap field 708g are included in A-ACK frame 700, and each instance of a field set is uniquely associated with one of the n TIDs. The length of acknowledgement information included in bitmap field 708g is specified by the associated length field 708e for acknowledgment information of a particular TID. Advantageously, A-ACK frame 700 provides the flexibility to acknowledge from 1 to 256*8 MPDUs or MSDUs.

With reference now to FIG. 8, a diagrammatic representation of an embodiment of a frame sequence and aggregate acknowledgment exchanged between initiator and responder stations is shown. In the illustrative example, an initiator, such as WLAN station 20 shown in FIG. 1, transmits frame sequence 800 comprising a plurality of frames 810a-812c to a responder station, such as WLAN station 23 shown in FIG. 1. Frames 810a-812c are representative of frames that contain MAC protocol data units of various traffic streams and are illustratively designated as MPDU_{X}-Y, where X designates a traffic stream and Y designates a frame number. As referred to herein, a frame subset comprises a subset of a frame sequence and has one or more frames belonging to a particular traffic stream. Thus, a frame subset comprising three frames 810a-810c of a traffic stream “1” are shown transmitted from an initiator station to a responder station. Likewise, respective frame subsets of three frames 811a-811c and 812a-812c of traffic streams “2” and “3” are shown transmitted from the initiator station to the responder station.

In accordance with a preferred embodiment of the present invention, a variable length A-ACK frame 820 is transmitted by the responder station responsive to the receipt of frame sequence 800. A-ACK frame 800 is adapted to acknowledge frames of one or more TIDs (or, alternatively, frames not associated with a TID). As described above, the field lengths of A-ACK frame 820 that include acknowledgment information regarding the receipt status of frame sequence 800 are dependent on the number of frames of frame sequence 800 being acknowledged. Thus, the length (as measured in bits, bytes, or the like) of A-ACK frame 820 is variable and dependent on the number of frames being acknowledged. Consequently, the length L as a duration of time that A-ACK frame 820 consumes a wireless medium resource, e.g., one or more channels, is dependent on the number of frames being acknowledged by A-ACK frame 820.

While FIG. 8 depicts a single A-ACK being sent for acknowledgment of multiple TIDs and multiple MPDUs per TID that are received by a station, it should be understood that a variable length aggregate ACK frame may be sent for a group of one or more MPDUs for each TID, or an aggregated ACK frame may be sent for a group of one or more MPDUs of different TIDs without departing from the spirit of the invention.

As described, embodiments provide mechanisms for producing a variable length aggregate acknowledgment frame in a shared resource network. A plurality of frames is received, and receipt status information regarding the plurality of frames is generated. An aggregate acknowledgment frame comprising an acknowledgment information field containing the receipt status information is produced. A length of the receipt status information is dependent on a number of the plurality of frames.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of generating frame acknowledgement information, comprising:
receiving a plurality of frames;
generating receipt status information regarding the plurality of frames; and
producing an aggregate acknowledgment frame comprising an acknowledgment information field containing the receipt status information, wherein a length of the receipt status information is dependent on a number of the plurality of frames.

2. The method of claim 1, wherein receiving the plurality of frames comprises receiving a plurality of frame subsets each associated with one of a plurality of traffic identifiers.

3. The method of claim 2, further comprising generating a plurality of field sets in the acknowledgment information field each respectively associated with one of the plurality of traffic identifiers, wherein each field set includes at least one sequence number and receipt status information of frames of the associated traffic identifier, and wherein receipt status information of a field set is of a length that is dependent on a number of frames of the associated traffic identifier.

4. The method of claim 3, wherein the receipt status information in each field set respectively comprises an acknowledgement bitmap.

5. The method of claim 3, wherein the at least one sequence number included in each field set respectively comprises a sequence number of a first frame of the associated traffic identifier having receipt status in the receipt status information of the field set.

6. The method of claim 3, further comprising producing a respective length field in the acknowledgement information field for each field set that specifies a length of the receipt status information included in the field set.

7. The method of claim 1, further comprising implicitly determining the length of the receipt status information.

8. The method of claim 1, further comprising producing a frame count field in the acknowledgment information field that specifies a number of frames having acknowledgment information included in the aggregate acknowledgement frame.

9. A computer-readable medium having computer-executable instructions for execution by a computer system, the computer-executable instructions for performing a method of generating frame acknowledgment information, the computer-executable instructions comprising:
first instructions that receive a plurality of frames;
second instructions that generate receipt status information regarding the plurality of frames; and
third instructions that produce an aggregate acknowledgment frame comprising an acknowledgment information field that includes the receipt status information, wherein a length of the receipt status information is dependent on a number of the plurality of frames.

10. The computer-readable medium of claim 9, wherein the plurality of frames received by the first instructions comprises a plurality of frame subsets each respectively associated with one of a plurality of traffic identifiers.

11. The computer-readable medium of claim 10, further comprising fourth instructions that produce a plurality of field sets in the acknowledgement information field each respectively associated with one of the plurality of traffic identifiers, wherein each field set includes at least one sequence number and receipt status information of frames of the associated traffic identifier, and wherein the receipt status information of a field set has a length that is dependent on a number of frames of the associated traffic identifier.

12. The computer-readable medium of claim 11, wherein the receipt status information in each field set respectively comprises an acknowledgement bitmap data structure.

13. The computer-readable medium of claim 11, wherein the at least one sequence number included in each field set respectively comprises a sequence number of a first frame of the associated traffic identifier having receipt status in the receipt status information of the field set.

14. The computer-readable medium of claim 11, further comprising fifth instructions that produce a respective length field in the acknowledgment information field for each field set that specifies a length of the receipt status information included in the field set.

15. The computer-readable medium of claim 9, further comprising fourth instructions that implicitly determine the length of the receipt status information.

16. The computer-readable medium of claim 9, further comprising fourth instructions that produce a frame count field in the acknowledgment information field that specifies a number of frames having acknowledgement information included in the aggregate acknowledgment frame.

17. A device adapted to perform communications in a shared resource network, comprising:
a memory adapted to store a plurality of frames; and
a processing unit adapted to generate receipt status information regarding the plurality of frames, and produce an aggregate acknowledgement frame comprising an acknowledgment information field that includes the receipt status information, wherein a length of the receipt status information is dependent on a number of the plurality of frames.

18. The device of claim 17, wherein the plurality of frames comprises a plurality of frame subsets each respectively associated with one of a plurality of traffic identifiers.

19. The device of claim 18, wherein the processing unit generates a plurality of field sets in the acknowledgement information field each respectively associated with one of the plurality of traffic identifiers, wherein each field set includes at least one sequence number and receipt status information of frames of the associated traffic identifier, and wherein receipt status information of a field set has a length that is dependent on a number of frames of the associated traffic identifier.

20. The device of claim 19, wherein the receipt status information in each field set respectively comprises an acknowledgment bitmap.

21. The device of claim 19, wherein the at least one sequence number included in each field set respectively comprises a sequence number of a first frame of the associated traffic identifier having receipt status in the receipt status information of the field set.

22. The device of claim 17, wherein the processing unit produces a frame count field in the acknowledgment information field that specifies a number of frames having acknowledgement information included in the aggregate acknowledgment frame

23. The device of claim 17, wherein the device comprises a wireless local area network device, and wherein the acknowledgement frame comprises a media access control frame.

24. The device of claim 17, further comprising a shared resource interface, wherein the plurality of frames are received by the device on the shared resource interface.

25. A device adapted to generate frame acknowledgment information, comprising:
means for receiving a plurality of frames;
means for generating receipt status information regarding the plurality of frames; and
means for producing an aggregate acknowledgment frame comprising an acknowledgment information field containing the receipt status information, wherein a length of the receipt status information is dependent on a number of the plurality of frames.

26. The device of claim 25, wherein the plurality of frames comprise first frames associated with a first traffic identifier and second frames associated with a second traffic identifier, the device further comprising means for generating a first field set associated with the first traffic identifier and a second field set associated with the second traffic identifier in the acknowledgment information field, wherein each field set includes at least one sequence number and receipt status information of frames of the associated traffic identifier, and wherein receipt status information of a field set is of a length that is dependent on a number of frames of the associated traffic identifier.

27. A system for data transmission, comprising:
a transmitter station comprising a shared resource interface, wherein the transmitter station generates a plurality of frames and transmits the plurality of frames on a shared resource medium by the shared resource interface; and
a receiver station comprising a shared resource interface that receives the plurality of frames, generates receipt status information regarding the plurality of frames, and produces an aggregate acknowledgment frame comprising an acknowledgment information field containing the receipt status information, wherein a length of the receipt status information is dependent on a number of the plurality of frames.

28. The system of claim 27, wherein the plurality of frames comprises a plurality of frame subsets each associated with one of a plurality of traffic identifiers, wherein the receiver station generates a plurality of field sets in the acknowledgment information field each respectively associated with one of the plurality of traffic identifiers, wherein each field set includes at least one sequence number and receipt status information of frames of the associated traffic identifier, and wherein receipt status information of a field set is of a length that is dependent on a number of frames of the associated traffic identifier.

29. A memory for storing data for access by a program being executed on a data processing system, comprising:
a data structure stored in the memory including information for verifying receipt of a plurality of frames, the data structure including:
receipt status information regarding a plurality of frames, wherein the receipt status information is of a length that depends on a number of the plurality of frames; and
an aggregate acknowledgment frame comprising an acknowledgement information field containing the receipt status information.

30. The memory of claim 29, wherein the plurality of frames comprise a plurality of frame subsets each associated with one of a plurality of traffic identifiers, the data structure further comprising a plurality of field sets in the acknowledgment information field each respectively associated with one of the plurality of traffic identifiers, wherein each field set includes at least one sequence number and receipt status information of frames of the associated traffic identifier, and wherein receipt status information of a field set is of a length that is dependent on a number of frames of the associated traffic identifier.
